(19) United States
(12) Patent Application Publication
(10) Pub. No.: US 2023/0222936 A1
(43) Pub. Date: Jul. 13, 2023

(54) INFORMATION PROCESSING APPARATUS, NON-TRANSITORY COMPUTER READABLE MEDIUM STORING INFORMATION PROCESSING PROGRAM, AND INFORMATION PROCESSING METHOD

(71) Applicant: FUJIFILM Business Innovation Corp., Tokyo (JP)

(72) Inventors: Satoru KUWA, Kanagawa (JP); Yasushi SANO, Kanagawa (JP); Koichi HOMMA, Kanagawa (JP)

(73) Assignee: FUJIFILM Business Innovation Corp., Tokyo (JP)

(21) Appl. No.: 17/938,906

(22) Filed: Sep. 6, 2022

(30) Foreign Application Priority Data
Jan. 12, 2022 (JP) 2022-003395

(51) Int. Cl. G09B 7/04; G06F 40/186; G06F 40/258

(52) U.S. Cl. CPC G09B 7/04; G06F 40/186; G06F 40/258

(57) ABSTRACT

An information processing apparatus includes a processor configured to select a teaching material related to a lesson from an answer to a questionnaire of the lesson in which the answer is written, and create a report associated with the selected teaching material.

### CROSS-REFERENCE TO RELATED APPLICATIONS

This application is based on and claims priority under 35 USC 119 from Japanese Patent Application No. 2022-003395 filed Jan. 12, 2022.

### BACKGROUND

### (i) Technical Field

The technology of the present invention relates to an information processing apparatus, a non-transitory computer readable medium storing an information processing program, and an information processing method.

### (ii) Related Art

A technology for creating a report in a cram school is present.

JP2005-182272A discloses an individual instruction management system including a management computer for business management of a cram school in which a teacher provides a lesson to a student, and a server that can be connected to the management computer and is installed in a head office of the cram school. A storage device of the server stores a server database including learning data of the entire cram school and a server program for operating the server. The server program includes a program for communicating between the server and the management computer, downloading learning data indicating progress in learning of the student and data related to the teacher from the management computer and adding the learning data and the data to the server database, obtaining statistics and collecting data for operation of the entire cram school, and outputting the statistics and the collected data.

### SUMMARY

In a lecture or the like, a teacher manually creates a questionnaire for each lesson and then, creates a report in which a teaching material appropriate for each student is described by referring to an answer of each student to the questionnaire.

Here, items of the questionnaire are different for each lesson content. In addition, the answer to the questionnaire is also different for each student. Thus, the teacher needs to make an effort to create the report that reflects the answer to the questionnaire.

Aspects of non-limiting embodiments of the present disclosure relate to an information processing apparatus, a non-transitory computer readable medium storing an information processing program, and an information processing method that can support creation of a report.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an information processing apparatus including a processor configured to select a teaching material related to a lesson from an answer to a questionnaire of the lesson in which the answer is written, and create a report associated with the selected teaching material.

### BRIEF DESCRIPTION OF THE DRAWINGS

Exemplary embodiment(s) of the present invention will be described in detail based on the following figures, wherein:

FIG. 1 is a schematic configuration diagram of an information processing system;

FIG. 2 is a block diagram illustrating a hardware configuration of an information processing apparatus according to a first exemplary embodiment;

FIG. 3 is a block diagram illustrating a hardware configuration of an image forming apparatus according to the first exemplary embodiment;

FIG. 4 is a block diagram illustrating a functional configuration of the information processing apparatus according to the first exemplary embodiment;

FIG. 5 is a block diagram illustrating a functional configuration of the image forming apparatus according to the first exemplary embodiment;

FIG. 6 is a schematic diagram illustrating a flow of report creation process of the information processing system according to the first exemplary embodiment;

FIG. 7 is a flowchart illustrating a flow of report creation process of the information processing apparatus according to the first exemplary embodiment;

FIG. 8 is an example illustrating a text with a two-dimensional code created by the information processing apparatus according to the first exemplary embodiment;

FIG. 9 is an example illustrating an answer to a questionnaire;

FIG. 10 is an example illustrating a report created by the information processing apparatus according to the first exemplary embodiment;

FIG. 11 is a block diagram illustrating a functional configuration of an information processing apparatus according to a second exemplary embodiment;

FIG. 12 is a schematic diagram illustrating a flow of questionnaire creation process of an information processing system according to the second exemplary embodiment;

FIG. 13 is a flowchart illustrating a flow of questionnaire creation process of the information processing apparatus according to the second exemplary embodiment; and

FIG. 14 is an example illustrating a questionnaire created by the information processing apparatus according to the second exemplary embodiment.

### DETAILED DESCRIPTION

Hereinafter, an example of an exemplary embodiment of the technology of the present invention will be described with reference to the drawings. Identical or equivalent constituents and parts are designated by identical reference numerals in each drawing. In addition, dimensional ratios in the drawings are exaggerated for convenience of description and may be different from actual ratios.

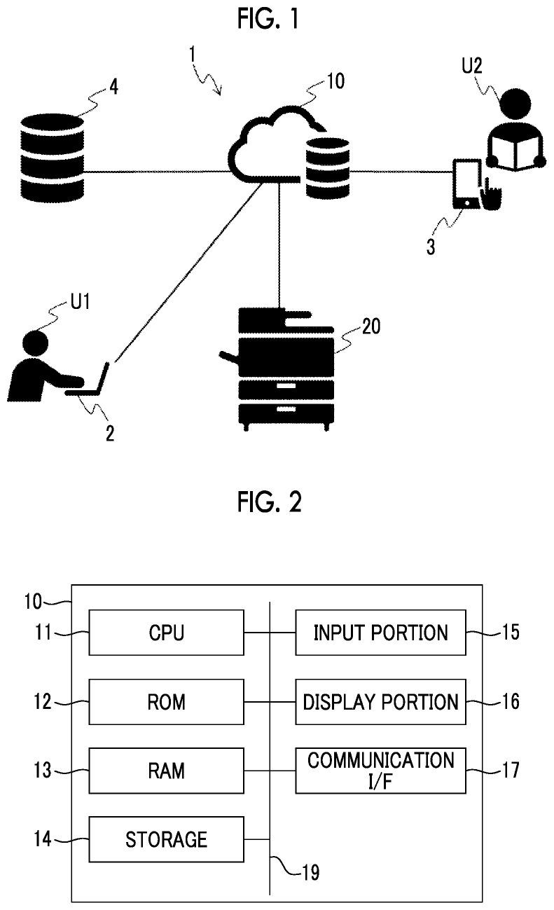

FIG. 1 is a schematic configuration diagram of an information processing system 1 according to the exemplary embodiment of the present disclosure. The information processing system 1 includes a terminal apparatus 2, a terminal apparatus 3, a teaching material database 4, an information processing apparatus 10, and an image forming apparatus 20.

The terminal apparatus 2 is a personal computer, a tablet terminal, a smartphone, or the like used by a user U1. The terminal apparatus 2 receives an operation of the user U1 to create a questionnaire about a lesson and transmit the questionnaire to the information processing apparatus 10. The information processing apparatus 10 receives an operation of the user U1 to designate a text and a questionnaire to be used in the lesson. The text includes a test. The questionnaire includes one or a plurality of question items and includes a comment field for writing a comment in a descriptive manner and a comprehensibility field for writing an comprehensibility degree for each question item. The question item is a subject of a question for an answerer. For example, the user U1 is an employee including a teacher in a school or a cram school.

The terminal apparatus 3 is a smartphone, a personal computer, a tablet terminal, or the like used by the user U2. The terminal apparatus 3 receives an operation of the user U2 to read a two-dimensional code and transmit the questionnaire answered by the user U2 to the information processing apparatus 10. For example, the user U2 is a student in a school or a cram school.

The teaching material database 4 is a database that stores meta-information of a teaching material including a title of the teaching material in association with content information including a content of the teaching material. The teaching material is a material used for learning and includes, for example, a textbook, a problem set, or a lesson video. For example, the meta-information of the teaching material is the title of the teaching material, a page number, a storage location, a course name, or a corresponding grade. For example, the content information is electronic data of the content of the teaching material. The teaching material database 4 receives a search performed by the information processing apparatus 10 and returns the meta-information or the content information of the teaching material that is a search result.

The information processing apparatus 10 creates the two-dimensional code for identifying the questionnaire and assigns the two-dimensional code to the text. The information processing apparatus 10 selects the teaching material related to the lesson from the teaching material database 4. The information processing apparatus 10 creates a report associated with the selected teaching material.

The image forming apparatus 20 is an image forming apparatus having a plurality of functions such as a facsimile function, an image reading function, an image forming function, a copying function, a storage function of storing image information or the like, and a transmission function of transmitting the image information or the like. The image forming apparatus 20 prints the text with the two-dimensional code received from the information processing apparatus 10.

### First Exemplary Embodiment

FIG. 2 is a block diagram illustrating a hardware configuration of the information processing apparatus 10 according to a first exemplary embodiment. The information processing apparatus 10 includes each configuration of a central processing unit (CPU) 11, a read only memory (ROM) 12, a random access memory (RAM) 13, a storage 14, an input portion 15, a display portion 16, and a communication interface (communication I/F) 17. These configurations are communicably connected to each other via a bus 19.

The CPU 11 is a central calculation processing unit and executes various programs or controls each portion. That is, the CPU 11 reads a program from the ROM 12 or the storage 14 and executes the program using the RAM 13 as a work region. The CPU 11 controls each configuration and performs various calculation processes in accordance with the program recorded in the ROM 12 or the storage 14. In the first exemplary embodiment, the ROM 12 or the storage 14 stores an information processing program for creating the report.

The ROM 12 stores various programs and various data. The RAM 13 temporarily stores a program or data as the work region. The storage 14 is configured with a hard disk drive (HDD) or a solid state drive (SSD) and stores various programs including an operating system and various data.

The input portion 15 includes a pointing device such as a mouse and a keyboard, and is used for providing various inputs.

The display portion 16 is, for example, a liquid crystal display and displays various information. The display portion 16 may function as the input portion 15 by employing a touch panel method.

The communication interface 17 is an interface for communicating with another apparatus such as a database and uses standards such as Ethernet (registered trademark), FDDI, and Wi-Fi (registered trademark).

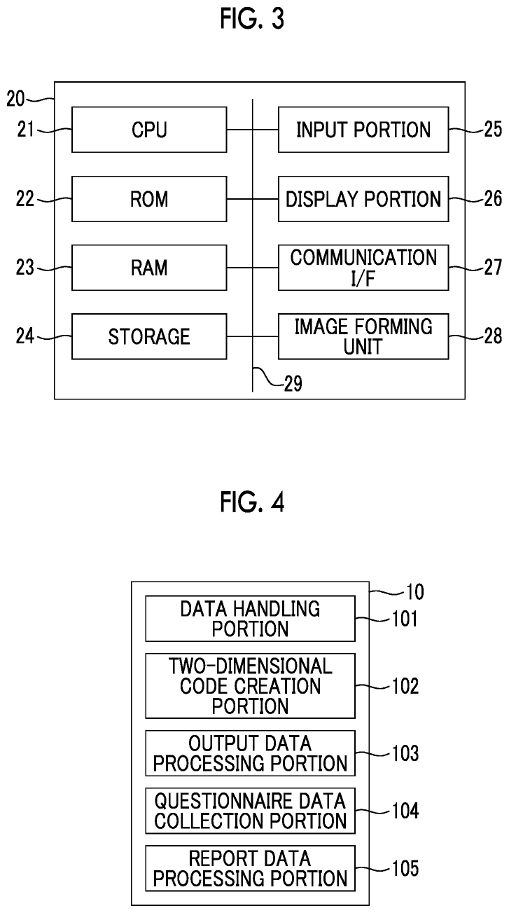

FIG. 3 is a block diagram illustrating a hardware configuration of the image forming apparatus 20 according to the first exemplary embodiment. The image forming apparatus 20 includes each configuration of a CPU 21, a ROM 22, a RAM 23, a storage 24, an input portion 25, a display portion 26, a communication interface (communication I/F) 27, and an image forming unit 28. These configurations are communicably connected to each other via a bus 29.

The CPU 21 is a central calculation processing unit and executes various programs or controls each portion. That is, the CPU 21 reads a program from the ROM 22 or the storage 24 and executes the program using the RAM 23 as a work region. The CPU 21 controls each configuration and performs various calculation processes in accordance with the program recorded in the ROM 22 or the storage 24. In the first exemplary embodiment, the ROM 22 or the storage 24 stores an information processing program for transmitting data.

The ROM 22 stores various programs and various data. The RAM 23 temporarily stores a program or data as the work region. The storage 24 is configured with an HDD or an SSD and stores various programs including an operating system and various data.

The input portion 25 includes a pointing device such as a mouse and a keyboard, and is used for providing various inputs. The input portion 25 is used for creating scan data by scanning a recording medium such as paper.

The display portion 26 is, for example, a liquid crystal display and displays various information. The display portion 26 may function as the input portion 25 by employing a touch panel method.

The communication interface 27 is an interface for communicating with another apparatus such as a database and uses standards such as Ethernet (registered trademark), FDDI, and Wi-Fi (registered trademark).

The image forming unit 28 forms print data on the recording medium such as paper. A toner method, an ink jet method, or the like is employed as a method of forming an image.

Next, a functional configuration of the information processing apparatus 10 will be described.

FIG. 4 is a block diagram illustrating an example of a functional configuration of the information processing apparatus 10 according to the first exemplary embodiment. The information processing apparatus 10 includes, as the functional configuration, a data handling portion 101, a two-dimensional code data creation portion 102, an output data processing portion 103, a questionnaire data collection portion 104, and a report data processing portion 105. Each functional configuration is implemented by causing the CPU 11 to read the information processing program stored in the ROM 12 or the storage 14, load the information processing program into the RAM 13, and execute the information processing program.

The data handling portion 101 manages information about the student who is the user U2.

The two-dimensional code data creation portion 102 creates data of the two-dimensional code including a QR code (registered trademark). The two-dimensional code is information for identifying the questionnaire. For example, the information for identifying the questionnaire is a uniform resource locator (URL) for answering the questionnaire, a file path of a location in which the questionnaire is stored, or an identification value assigned for each questionnaire.

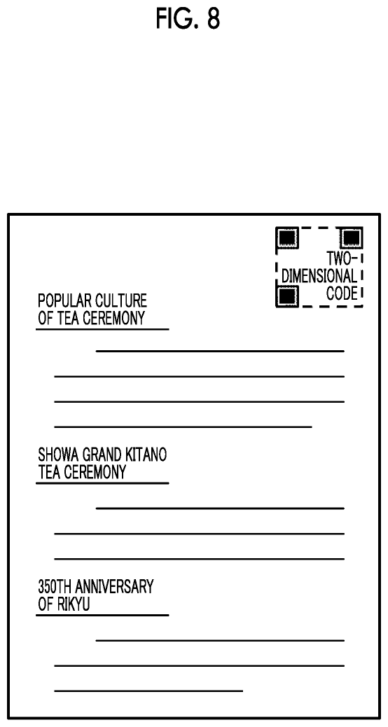

The output data processing portion 103 assigns the two-dimensional code to the text. The two-dimensional code may have any size at any position as long as the two-dimensional code can be read by the terminal apparatus 3 used by the user U2. A specific example of the text with the two-dimensional code will be described later using FIG. 8.

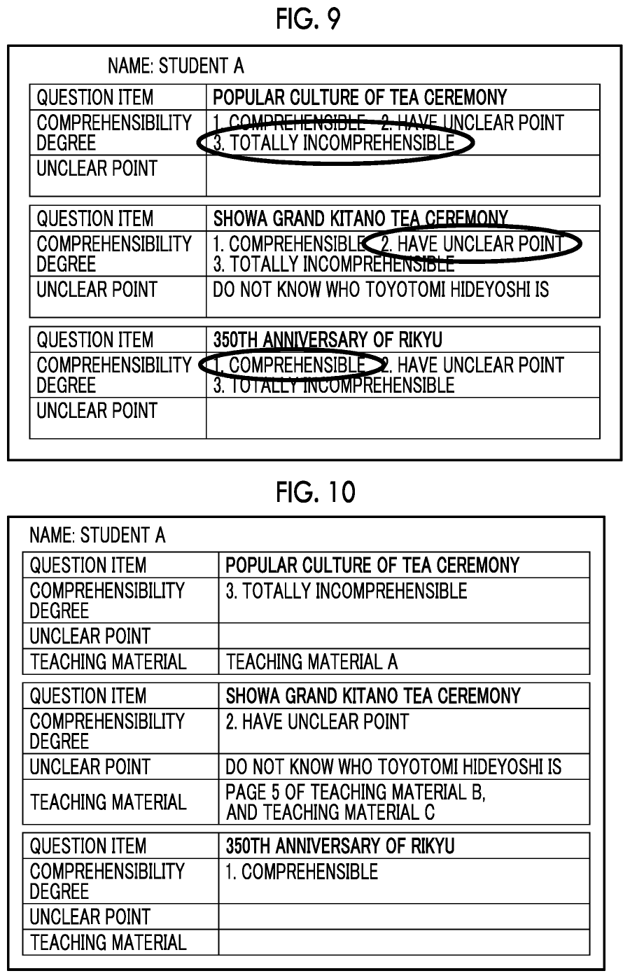

The questionnaire data collection portion 104 collects a result of the answered questionnaire for each student, each lesson, each question item of the questionnaire, or the like. A specific example of the answered questionnaire will be described later using FIG. 9.

The report data processing portion 105 creates the report associated with the answer to the questionnaire and the selected teaching material. A specific example of the report will be described later using FIG. 10.

Next, a functional configuration of the image forming apparatus 20 will be described.

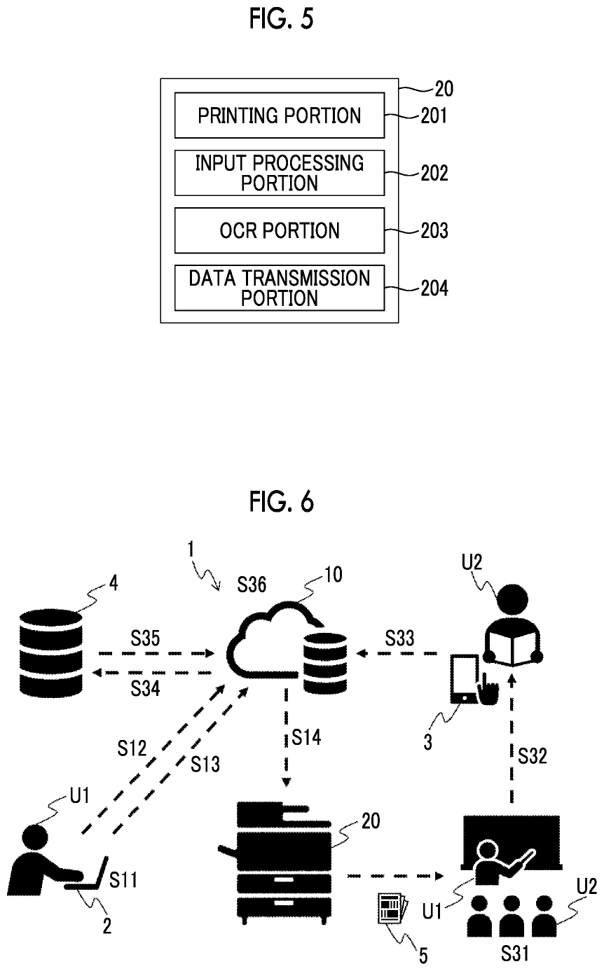

FIG. 5 is a block diagram illustrating an example of a functional configuration of the image forming apparatus 20 according to the first exemplary embodiment. The image forming apparatus 20 includes, as the functional configuration, a printing portion 201, an input processing portion 202, an optical character reader (OCR) portion 203, and a data transmission portion 204. Each functional configuration is implemented by causing the CPU 21 to read the information processing program stored in the ROM 22 or the storage 24, load the information processing program into the RAM 23, and execute the information processing program.

The printing portion 201 prints the text to which the two-dimensional code is assigned on the recording medium including paper using the image forming unit 28.

The input processing portion 202 executes scanning on the text or the like using the input portion 25.

The OCR portion 203 recognizes text data from the image using an OCR. For example, the OCR portion 203 extracts a heading from the text.

The data transmission portion 204 transmits scan data to the information processing apparatus 10 using the communication interface 27.

Next, an action of the information processing system 1 will be described.

FIG. 6 is a schematic diagram illustrating a flow of report creation process of the information processing system 1 according to the first exemplary embodiment.

In step S11, the terminal apparatus 2 receives an operation of the user U1 to create the questionnaire.

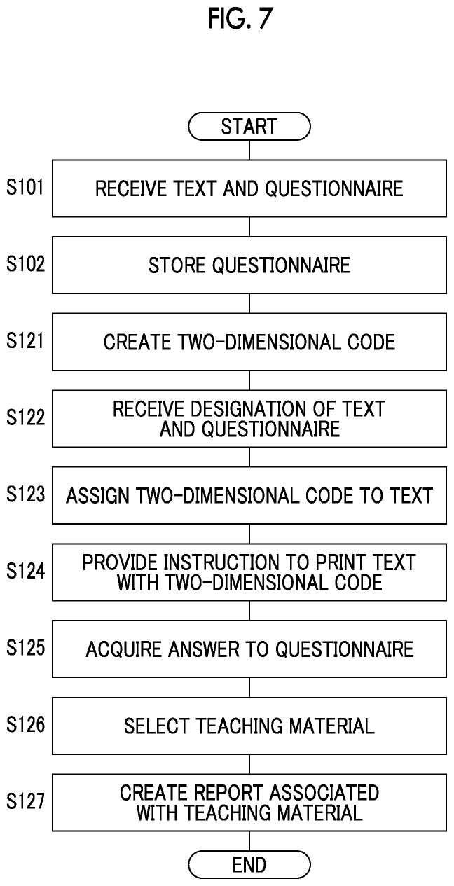

In step S12, the terminal apparatus 2 transmits the created questionnaire to the information processing apparatus 10. The information processing apparatus 10 creates the two-dimensional code for identifying the questionnaire. The process of step S12 corresponds to a process of step S101 to step S121, described later, in FIG. 7.

In step S13, the terminal apparatus 2 designates the text and the questionnaire to be used in the lesson in the information processing apparatus 10. The process of step S13 corresponds to a process of step S122, described later, in FIG. 7.

In step S14, the information processing apparatus 10 provides an instruction to print the text with the two-dimensional code by transmitting the text with the two-dimensional code to the image forming apparatus 20. The process of step S14 corresponds to a process of step S123 and step S124, described later, in FIG. 7.

In step S31, the image forming apparatus 20 prints the text with the two-dimensional code. The user U1 provides the lesson to the user U2 using a printed text 5 with the two-dimensional code.

In step S32, the terminal apparatus 3 receives an operation of the user U2 to read the two-dimensional code assigned to the printed text 5 with the two-dimensional code. The terminal apparatus 3 displays the questionnaire identified by the read two-dimensional code and receives the answer of the user to the questionnaire.

In step S33, the terminal apparatus 3 transmits the answer of the user U2 to the questionnaire to the information processing apparatus 10. The process of step S33 corresponds to a process of step S125, described later, in FIG. 7.

In step S34, the information processing apparatus 10 selects the related teaching material from the teaching material stored in the teaching material database 4 using a word included in the answer to the questionnaire as a search term.

In step S35, the teaching material database 4 transmits the selected teaching material that is the search result to the information processing apparatus 10. The process of step S34 and step S35 corresponds to a process of step S126, described later, in FIG. 7.

In step S36, the information processing apparatus 10 creates the report associated with the answer to the questionnaire and the selected teaching material. The process of step S36 corresponds to a process of step S127, described later, in FIG. 7.

FIG. 7 is a flowchart illustrating a flow of report creation process of the information processing apparatus 10 according to the first exemplary embodiment. The report creation process is performed by causing the CPU 11 to read the information processing program from the ROM 12 or the storage 14, load the information processing program into the RAM 13, and execute the information processing program.

In step S101, the CPU 11 receives the text and the questionnaire from the terminal apparatus 2. The CPU 11 transitions to step S102.

In step S102, the CPU 11 stores the received questionnaire. The CPU 11 transitions to step S121.

In step S121, the CPU 11 creates the two-dimensional code. For example, the CPU 11 creates the file path of the location in which the questionnaire is stored in the process of step S102 as the two-dimensional code. The CPU 11 transitions to step S122.

In step S122, the CPU 11 receives a designation of the text and the questionnaire. The CPU 11 transitions to step S123.

In step S123, the CPU 11 assigns the two-dimensional code to the text. That is, the CPU 11 assigns the two-dimensional code for identifying the designated questionnaire to the designated text. The CPU 11 transitions to step S124.

Here, FIG. 8 is an example of the text with the two-dimensional code obtained by assigning the two-dimensional code to the text. The CPU 11 assigns the two-dimensional code to the upper right of the text.

In step S124, the CPU 11 provides the instruction to print the text with the two-dimensional code. The CPU 11 transmits the text with the two-dimensional code to the image forming apparatus 20. The CPU 11 transitions to step S125.

In step S125, the CPU 11 acquires the answer to the questionnaire. That is, the CPU 11 acquires the answer to the questionnaire from the terminal apparatus 3 that has read the two-dimensional code. In other words, the CPU 11 acquires the answer, to the questionnaire, of the user U2 who has taken the lesson using the text with the two-dimensional code. The CPU 11 transitions to step S126.

Here, FIG. 9 is an example of the answer to the questionnaire. The questionnaire includes three question items and includes an unclear point item as the comment field and a comprehensibility degree item as the comprehensibility field. The comprehensibility field has degrees of “1. Comprehensible”, “2. Have unclear point”, and “3. Totally incomprehensible”. In the example of the answer to the questionnaire, the first question item is “Popular culture of tea ceremony”, the comprehensibility degree is “3. Totally incomprehensible”, and the unclear point is not written. Similarly, the second question item is “Showa Grand Kitano Tea Ceremony”, the comprehensibility degree is “2. Have unclear point”, and the unclear point is “Do not know who Toyotomi Hideyoshi is”. The third question item is “350th anniversary of Rikyu”, the comprehensibility degree is “1. Comprehensible”, and the unclear point is not written.

In step S126, the CPU 11 selects the teaching material. That is, the CPU 11 selects the teaching material related to the lesson from the answer to the questionnaire of the lesson in which the answer is written. Specifically, the CPU 11 selects the teaching material having the content information including the search term by searching for the word included in the answer from the teaching material database 4 as the search term. For example, the CPU 11 searches for the teaching material including the word extracted from the question item or the comment written in the comment field from the teaching material database 4. The CPU 11 transitions to step S127.

For example, the CPU 11 searches for the teaching material including “Popular culture of tea ceremony” that is the first question item. In a case where “Do not know who Toyotomi Hideyoshi is” is written in the comment field, the CPU 11 extracts “Toyotomi Hideyoshi” as a keyword and searches for the teaching material including “Toyotomi Hideyoshi”.

In addition, the CPU 11 may select more teaching materials for a question item having a low comprehensibility degree written in the comprehensibility field than for a question item having a high comprehensibility degree. For example, in a case where the comprehensibility degrees are “1. Comprehensible”, “2”, Have unclear point”, and “3. Totally incomprehensible”, the CPU 11 selects zero, one, and two teaching materials in order.

In step S127, the CPU 11 creates the report associated with the teaching material. Here, for example, the report associated with the teaching material is a report in which the title or the like of the teaching material that is the meta-information of the teaching material is written. The CPU 11 may create a report associated with the teaching material or the comment for each question item. The CPU 11 may create the report associated with the answer to the questionnaire and the selected teaching material. The CPU 11 creates the report for each lesson or each student. The CPU 11 finishes the report creation process.

Here, FIG. 10 is an example of the report created from the answer to the questionnaire in FIG. 9. The CPU 11 writes “teaching material A” that is the teaching material selected in the process of step S126 into a teaching material field for the first question item. Similarly, the CPU 11 writes “page 5 of teaching material B” and “teaching material C” for the second question item.

By the process of step S125 to step S127 described above, the teaching material related to the lesson is selected from the answer to the questionnaire of the lesson in which the answer is written, and the report associated with the selected teaching material is created.

### Second Exemplary Embodiment

Next, a second exemplary embodiment will be described. In a method of the second exemplary embodiment, a process of creating the questionnaire is performed in addition to the configuration of the first exemplary embodiment. A hardware configuration of the second exemplary embodiment is identical to the hardware configuration of the first exemplary embodiment. Parts of the same configurations and actions as the first exemplary embodiment will be designated by identical reference numerals and will not be described.

A functional configuration of the information processing apparatus 10 will be described.

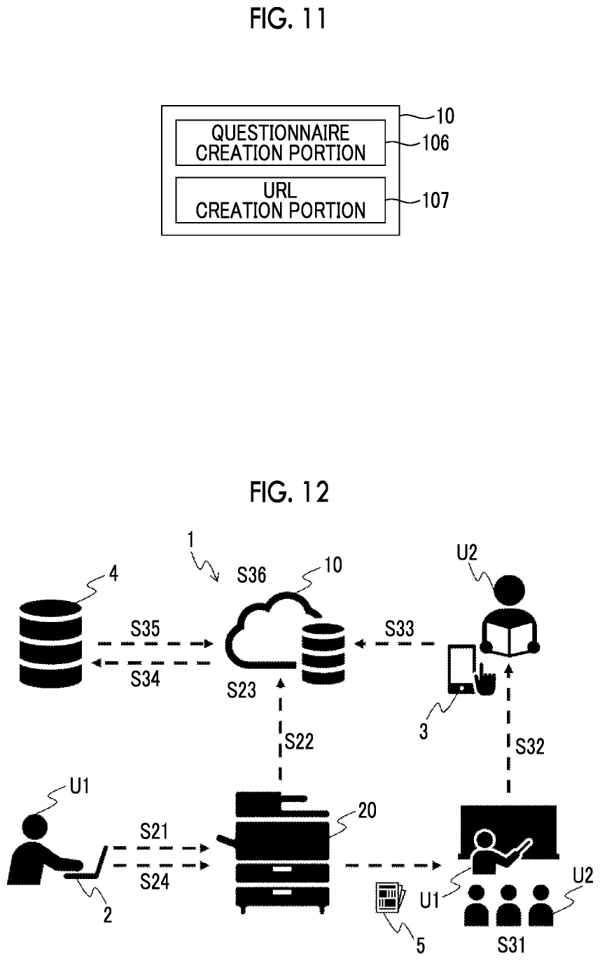

FIG. 11 is a block diagram illustrating an example of a functional configuration of the information processing apparatus 10 according to the second exemplary embodiment. The information processing apparatus 10 further includes a questionnaire creation portion 106 and a URL creation portion 107 as the functional configuration.

The questionnaire creation portion 106 creates the questionnaire. Specifically, the questionnaire creation portion 106 associates the heading extracted from the text used in the lesson with the question item. The questionnaire creation portion 106 creates the questionnaire including the question item for each heading in accordance with a predetermined template.

The URL creation portion 107 creates a URL of a WEB page for answering the questionnaire.

Next, an action of the information processing system 1 will be described.

FIG. 12 is a schematic diagram illustrating a flow of questionnaire creation process of the information processing system 1 according to the second exemplary embodiment.

In step S21, the image forming apparatus 20 receives an operation of the user U1 to create the scan data by scanning the text.

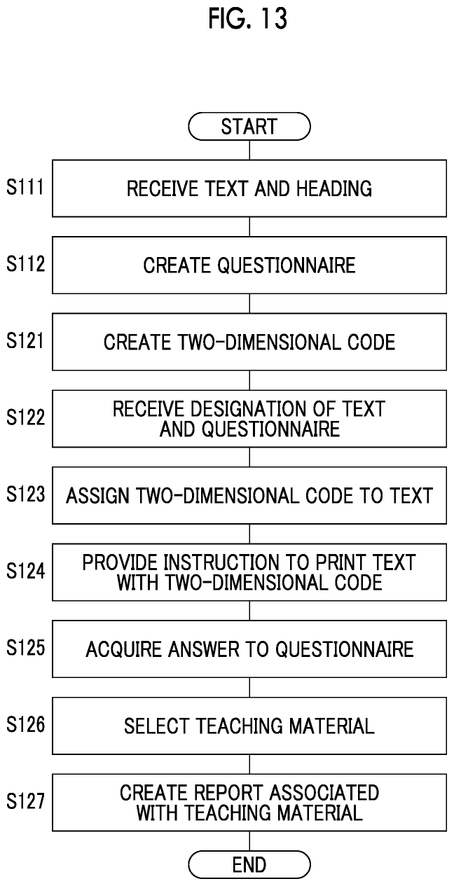

In step S22, the image forming apparatus 20 transmits the scan data and the heading extracted from the scan data to the information processing apparatus 10. The process of step S22 corresponds to a process of step S111, described later, in FIG. 13.

In step S23, the information processing apparatus 10 creates the questionnaire and the text with the two-dimensional code. The information processing apparatus 10 receives a transmission request from the image forming apparatus 20 and transmits the text with the two-dimensional code to the image forming apparatus 20. The process of step S23 corresponds to a process of step S112, described later, in FIG. 13.

In step S24, the terminal apparatus 2 provides the instruction to print the text with the two-dimensional code to the image forming apparatus 20.

The process of step S31 to step S36 is the same process as each of the above steps in FIG. 6.

FIG. 13 is a flowchart illustrating a flow of questionnaire creation process of the information processing apparatus 10 according to the second exemplary embodiment. The questionnaire creation process is performed by causing the CPU 11 to read the information processing program from the ROM 12 or the storage 14, load the information processing program into the RAM 13, and execute the information processing program.

In step S111, the CPU 11 receives the text and the heading. That is, the CPU 11 receives the scan data of the text and the heading extracted from the text using the OCR from the image forming apparatus 20. The CPU 11 transitions to step S112.

In step S112, the CPU 11 creates the questionnaire. For example, the CPU 11 associates the heading with the question item and creates the questionnaire including the question item for each heading in accordance with the predetermined template. The CPU 11 transitions to step S121.

The process of step S121 to step S127 is the same process as each of the above steps in FIG. 7.

By the process of step S111 to step S112 described above, the heading extracted from the text used in the lesson is associated with the question item, and the questionnaire including the question item for each heading is created in accordance with the predetermined template.

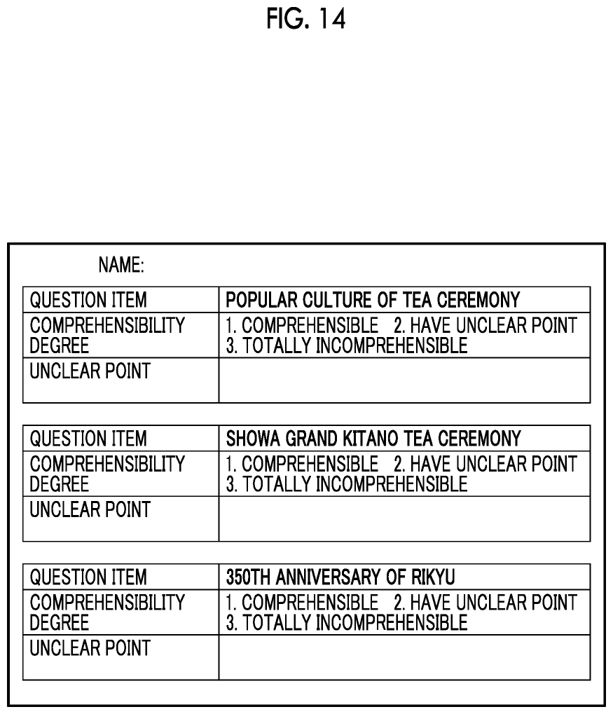

FIG. 14 is an example of the questionnaire created from the heading of the text in FIG. 8 by the information processing apparatus 10 according to the second exemplary embodiment. The information processing apparatus 10 receives “Popular culture of tea ceremony”, “Showa Grand Kitano Tea Ceremony”, and “350th anniversary of Rikyu” from the image forming apparatus 20 as the heading of the text and creates the questionnaire including “Popular culture of tea ceremony”, “Showa Grand Kitano Tea Ceremony”, and “350th anniversary of Rikyu” as the question item.

### Modification Example

The information processing apparatus 10 of the first exemplary embodiment and the second exemplary embodiment is described above. However, the present disclosure is not limited to the exemplary embodiments. Various improvements or modifications can be made.

The information processing apparatus 10 according to the first exemplary embodiment or the second exemplary embodiment may create the text from the teaching material stored in the database and create the report associated with a teaching material different from the teaching material from which the text is created. In step S101 in FIG. 7, the CPU 11 may create the text instead of receiving the text. The CPU 11 creates the report associated with the teaching material different from the teaching material from which the text is created. The CPU 11 may create the text including a heading from a part of the content including the heading in the teaching material stored in the database.

The information processing apparatus 10 according to the first exemplary embodiment or the second exemplary embodiment may be in the form of being mounted in the image forming apparatus 20. For example, the image forming apparatus 20 creates the questionnaire from the scanned text. In addition, the image forming apparatus 20 generates the two-dimensional code for identifying the created questionnaire.

The above process can also be implemented by a dedicated hardware circuit. In this case, the process may be executed by one piece of hardware or may be executed by a plurality of pieces of hardware.

In the embodiments above, the term “processor” refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device).

In the embodiments above, the term “processor” is broad enough to encompass one processor or plural processors in collaboration which are located physically apart from each other but may work cooperatively. The order of operations of the processor is not limited to one described in the embodiments above, and may be changed.

In addition, the program for operating the information processing apparatus 10 may be provided by a computer readable recording medium such as a universal serial bus (USB) memory, a flexible disk, or a compact disc read only memory (CD-ROM) or may be provided online via a network such as the Internet. In this case, the program recorded in the computer readable recording medium is normally transmitted to a memory, a storage, or the like and stored. In addition, for example, the program may be provided as standalone application software or may be incorporated into software of each apparatus as one function of the information processing apparatus 10.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An information processing apparatus comprising:
a processor configured to:
select a teaching material related to a lesson from an answer to a questionnaire of the lesson in which the answer is written; and
create a report associated with the selected teaching material.

2. The information processing apparatus according to claim 1, wherein the processor is configured to:
create the report associated with the answer to the questionnaire and the selected teaching material.

3. The information processing apparatus according to claim 1,
wherein the questionnaire includes one or a plurality of question items, and
the processor is configured to:
select the teaching material including a word included in the question item, and
create the report associated with the teaching material for each question item.

4. The information processing apparatus according to claim 2,
wherein the questionnaire includes one or a plurality of question items, and
the processor is configured to:
select the teaching material including a word included in the question item, and
create the report associated with the teaching material for each question item.

5. The information processing apparatus according to claim 3,
wherein the questionnaire includes a comment field for writing a comment for each question item, and
the processor is configured to:
select the teaching material including a word extracted from the comment written in the comment field, and
create the report associated with the teaching material and the comment for each question item.

6. The information processing apparatus according to claim 4,
wherein the questionnaire includes a comment field for writing a comment for each question item, and
the processor is configured to:
select the teaching material including a word extracted from the comment written in the comment field, and
create the report associated with the teaching material and the comment for each question item.

7. The information processing apparatus according to claim 3,
wherein the questionnaire includes a comprehensibility field for writing a comprehensibility degree for each question item, and
the processor is configured to:
select more teaching materials for a question item having a low comprehensibility degree written in the comprehensibility field than for a question item having a high comprehensibility degree.

8. The information processing apparatus according to claim 4,
wherein the questionnaire includes a comprehensibility field for writing a comprehensibility degree for each question item, and
the processor is configured to:
select more teaching materials for a question item having a low comprehensibility degree written in the comprehensibility field than for a question item having a high comprehensibility degree.

9. The information processing apparatus according to claim 5,
wherein the questionnaire includes a comprehensibility field for writing a comprehensibility degree for each question item, and
the processor is configured to:
select more teaching materials for a question item having a low comprehensibility degree written in the comprehensibility field than for a question item having a high comprehensibility degree.

10. The information processing apparatus according to claim 6,
wherein the questionnaire includes a comprehensibility field for writing a comprehensibility degree for each question item, and
the processor is configured to:
select more teaching materials for a question item having a low comprehensibility degree written in the comprehensibility field than for a question item having a high comprehensibility degree.

11. The information processing apparatus according to claim 3, wherein the processor is configured to:
associate a heading extracted from a text used in the lesson with the question item and create the questionnaire including the question item for each heading in accordance with a predetermined template.

12. The information processing apparatus according to claim 4, wherein the processor is configured to:
associate a heading extracted from a text used in the lesson with the question item and create the questionnaire including the question item for each heading in accordance with a predetermined template.

13. The information processing apparatus according to claim 5, wherein the processor is configured to:
associate a heading extracted from a text used in the lesson with the question item and create the questionnaire including the question item for each heading in accordance with a predetermined template.

14. The information processing apparatus according to claim 6, wherein the processor is configured to:
associate a heading extracted from a text used in the lesson with the question item and create the questionnaire including the question item for each heading in accordance with a predetermined template.

15. The information processing apparatus according to claim 7, wherein the processor is configured to:
associate a heading extracted from a text used in the lesson with the question item and create the questionnaire including the question item for each heading in accordance with a predetermined template.

16. The information processing apparatus according to claim 11, wherein the processor is configured to:
create a two-dimensional code for identifying the created questionnaire, and
assign the two-dimensional code to the text.

17. The information processing apparatus according to claim 11, wherein the processor is configured to:
select, in a database storing meta-information of the teaching material including a title of the teaching material in association with content information including a content of the teaching material, the teaching material having the content information including a search term by searching for a word included in the answer as the search term, and
create the report associated with the meta-information of the selected teaching material.

18. The information processing apparatus according to claim 17, wherein the processor is configured to:
create a text used in the lesson from the teaching material stored in the database, and
create the report associated with a teaching material different from the teaching material from which the text is created.

19. A non-transitory computer readable medium storing an information processing program causing a computer to execute a process comprising:
selecting a teaching material related to a lesson from an answer to a questionnaire of the lesson in which the answer is written; and
creating a report associated with the selected teaching material.

20. An information processing method comprising:
selecting a teaching material related to a lesson from an answer to a questionnaire of the lesson in which the answer is written; and
creating a report associated with the selected teaching material.
